(19) United States
(12) Patent Application Publication
(10) Pub. No.: US 2018/0076989 A1
(43) Pub. Date: Mar. 15, 2018

(54) TRANSMISSION DEVICE WITH PULSE WIDTH MODULATION

(71) Applicant: FUJITSU LIMITED, Kawasaki-shi (JP)

(72) Inventor: Alexander Nikolaevich LOZHKIN, Kawasaki (JP)

(73) Assignee: FUJITSU LIMITED, Kawasaki-shi (JP)

(21) Appl. No.: 15/626,419

(22) Filed: Jun. 19, 2017

(30) Foreign Application Priority Data
Sep. 15, 2016 (JP) 2016-180304

(51) Int. Cl. H04L 25/49

(52) U.S. Cl. CPC H04L 25/4902

(57) ABSTRACT

A transmission device outputs a modulated signal based on amplitude information and phase information respectively indicating an amplitude and a phase of a transmission symbol. The transmission device includes: an amplitude corrector configured to correct the amplitude information based on a specified carrier frequency; a phase corrector configured to correct the phase information based on the carrier frequency; a D/A converter configured to convert the corrected amplitude information into an analog signal so as to generate an amplitude information signal; an oscillator circuit configured to generate an oscillation signal that has a phase corresponding to the corrected phase information; a comparator configured to generate a pulse width modulated signal based on a comparison between the amplitude information signal and the oscillation signal; and a bandpass filter configured to filter the pulse width modulated signal so as to output the modulated signal.

### CROSS-REFERENCE TO RELATED APPLICATION

This application is based upon and claims the benefit of priority of the prior Japanese Patent Application No. 2016-180304, filed on Sep. 15, 2016, the entire contents of which are incorporated herein by reference.

### FIELD

The present invention is related to a transmission device that generates a modulated signal by using a pulse width modulation and transmits the modulated signal.

### BACKGROUND

As a scheme to reduce the cost for configuring a radio communication system, a distributed antenna system (DAS) has been implemented. In the distributed antenna system, a signal processing device that processes a transmission signal and a radio device that outputs a radio signal are separated. In the following description, the signal processing device may be referred to as a “digital processing unit”. The radio device may be referred to as a “remote radio unit (RRU)” or a “remote radio head (RRH)”.

A digital processing unit includes a transmission device that generates an analog modulated signal from digital data and transmits the analog modulated signal to a remote radio unit. In this case, the transmission device transmits, for example, an analog modulated signal of a radio frequency or an intermediate frequency to the remote radio unit. A transmission between a digital processing unit and a remote radio unit is implemented by, for example, radio over fiber (RoF). A radio frequency signal (RF signal) or an intermediate frequency signal (IF signal) is transmitted via an optical fiber in radio over fiber. The configuration in which an intermediate frequency signal is transmitted via an optical fiber may be referred to as IFoF (intermediate frequency over fiber). IFoF is one aspect of RoF.

The remote radio unit includes a transmission device that transmits a modulated signal received from the digital processing unit to a mobile station. In this case, the transmission device transmits an RF modulated signal to the mobile station via an antenna.

The transmission device includes, for example, a square wave modulator 1, an amplifier 2, and a bandpass filter (BPF) 3, as illustrated in FIG. 1. The square wave modulator 1 generates a PWM (pulse width modulation) signal corresponding to an amplitude and a phase of an input modulated signal. A width of a pulse corresponds to an amplitude Aᵢₙ of the input modulated signal. A timing of a pulse (that is, a position of a pulse in the time domain) corresponds to a phase φᵢₙ of the input modulated signal. A repetition frequency of a pulse train corresponds to a carrier frequency of an output signal of the transmission device. The amplifier 2 amplifies the PWM signal. Since the PWM signal is a two-level signal (in monopolar PWM), the amplifier 2 can amplify the PWM signal by switching operation. Thus, the amplifier 2 may be implemented by, for example, an efficient class-D high-power amplifier. The BPF 3 extracts a carrier frequency component. According to the configuration, the transmission device can amplify the input modulated signal and transmit the amplified signal. It is preferable that a phase φₒᵤₜ of the output signal of the transmission device match the phase φᵢₙ of the input modulated signal.

As described above, according to a configuration in which an input data signal is converted into a PWM signal on the input side of an amplifier and a bandpass filter is implemented on the output side of the amplifier, an efficiency of the amplifier improves. Note that technologies of processing a signal using PWM are described, for example, in Japanese Laid-open Patent Publication No. 2003-092522, Japanese Laid-open Patent Publication No. 59-104803, and Japanese National Publication of International Patent Application No. 2005-519514.

In addition, documents 1-3 listed below also describe technologies of processing a signal using PWM.
Document 1: F. H. Raab, Radio Frequency Pulsewidth Modulation, IEEE Trans on Communications, vol. 21, No. 8, pp. 958-966, August 1973
Document 2: Michael Nielsen et al., An RF Pulse Width Modulator for Switch-Mode Power Amplification of Varying Envelope Signals, Topical Meeting on Silicon Monolithic Integrated Circuit in RF Systems, pp. 277-280, 2007 IEEE
Document 3: S. Rosnell et al., Bandpass Pulse-Width Modulation, Nokia, TP Wireless Platforms, FIN-24100 Salo, Finland, pp. 731-734, 2005 IEEE

It is preferable that a transmission device be able to generate a transmission signal of a desired frequency. For example, in a communication system in which a plurality of frequency channels of different carrier frequencies are multiplexed illustrated in FIG. 2, it is preferable that a transmission device be able to transmit a signal in a desired frequency channel.

However, when a transmission device is configured as illustrated in FIG. 1, an oscillator that generates an oscillation signal of a carrier frequency is used in the square wave modulator 1. In this case, when the transmission device transmits a signal in a frequency channel CH1, the oscillator generates an oscillation signal of a frequency f1. When the transmission device transmits a signal in a frequency channel CH2, the oscillator generates an oscillation signal of a frequency f2. Therefore, when the transmission device transmits a signal in a frequency channel of a high carrier frequency, an operating frequency of a circuit in the square wave modulator 1 increases and thus a power consumption of the square wave modulator 1 increases.

### SUMMARY

According to an aspect of the present invention, a transmission device outputs a modulated signal based on amplitude information and phase information respectively indicating an amplitude and a phase of a transmission symbol. The transmission device includes: an amplitude corrector configured to correct the amplitude information based on a specified carrier frequency; a phase corrector configured to correct the phase information based on the carrier frequency; a D/A (digital-to-analog) converter configured to convert the amplitude information corrected by the amplitude corrector into an analog signal so as to generate an amplitude information signal; an oscillation signal generation circuit configured to generate an oscillation signal that has a phase corresponding to the phase information corrected by the phase corrector; a comparator configured to generate a pulse width modulated signal based on a comparison between the amplitude information signal and the oscillation signal; and a bandpass filter configured to filter the pulse width modulated signal so as to output the modulated signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a transmission device that generates a modulated signal using a pulse width modulation and transmits the modulated signal.

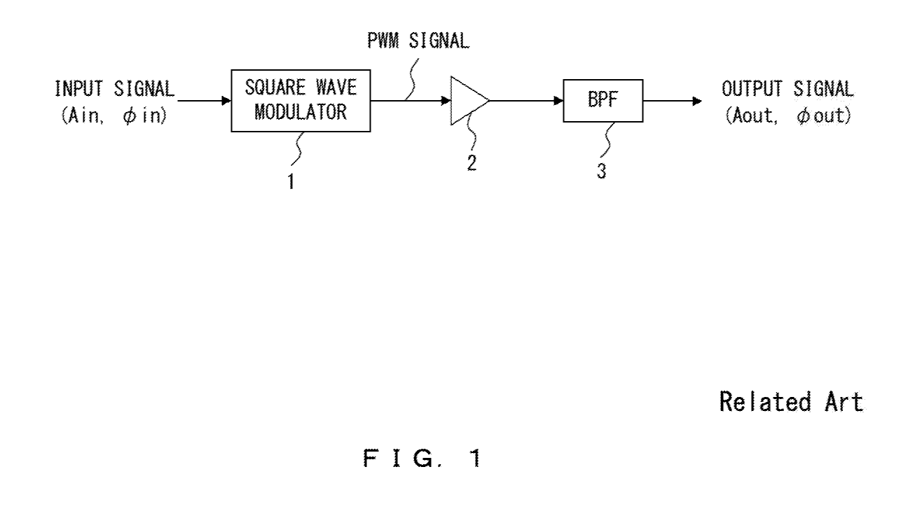

FIG. 2 illustrates an example of a communication system in which a plurality of frequency channels are multiplexed.

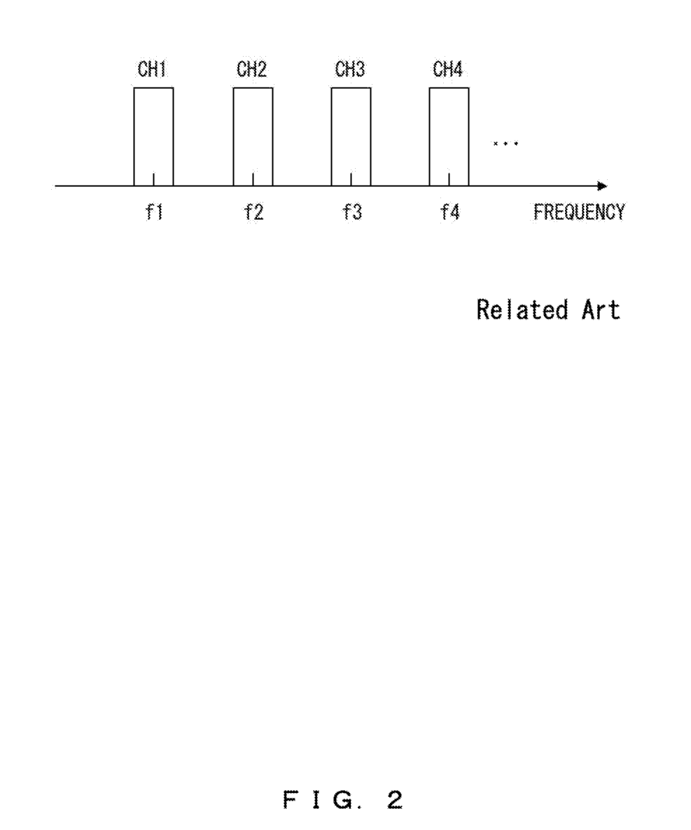

FIG. 3 illustrates an example of a transmission device according to an embodiment of the present invention.

FIGS. 4A and 4B illustrate an outline of an operation of a pulse width modulator.

FIG. 5 illustrates an example of a pulse width modulator.

FIGS. 6A and 6B illustrate relationships between amplitude information and a pulse width.

FIG. 7 illustrates an example of a mapping by the amplitude corrector.

FIG. 8 illustrates an example of spectrum of an output signal from the pulse width modulator.

FIGS. 9A and 9B illustrate examples of frequency channel selection.

FIGS. 10A and 10B illustrate examples of mappings with respect to a fundamental frequency and harmonic frequencies.

### DESCRIPTION OF EMBODIMENTS

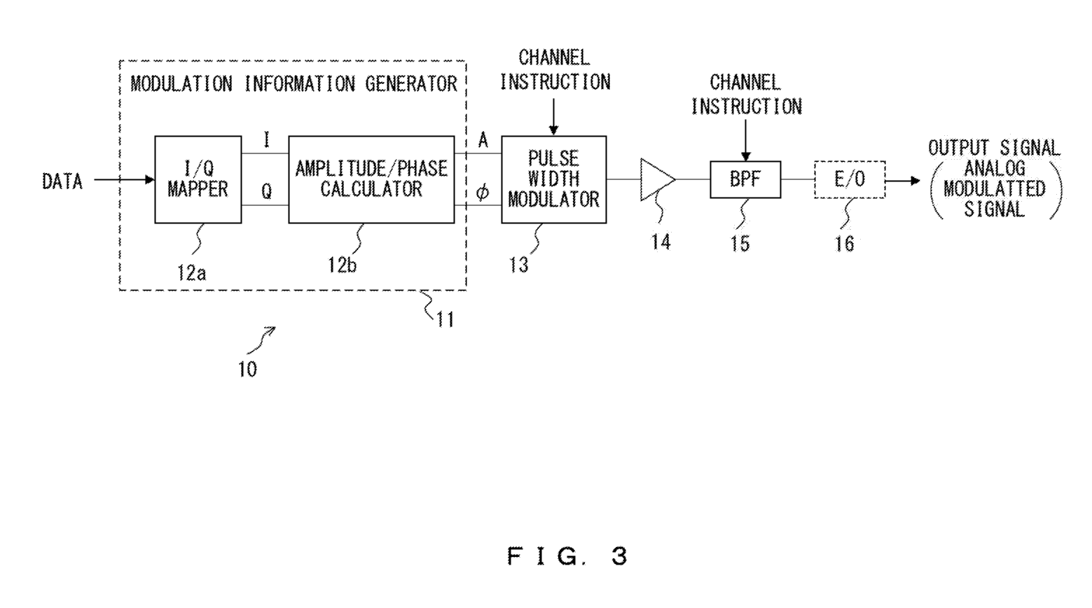

FIG. 3 illustrates an example of a transmission device according to an embodiment of the present invention. The transmission device 10 according to the embodiment includes a modulation information generator 11, a pulse width modulator 13, an amplifier 14 and a bandpass filter (BPF) 15, as illustrated in FIG. 3.

The transmission device 10 may be implemented in, for example, a digital processing unit of a distributed antenna system and used for transmitting a modulated signal to the remote radio unit. In this case, a digital data signal is input to the transmission device 10. The digital data signal may be an OFDM (orthogonal frequency division multiplexing) signal. In addition, the transmission device 10 may be implemented in the remote radio unit of the distributed antenna system and used for transmitting a modulated signal received from the digital processing unit to a mobile station. In this case, the transmission device transmits an RF modulated signal to the mobile station via an antenna. In the description below, embodiments in which the transmission device 10 is implemented in the digital processing unit will be discussed.

The modulation information generator 11 includes an I/Q mapper 12a and an amplitude/phase calculator 12b in this example. The I/Q mapper 12a generates a symbol sequence from an input data signal according to a specified modulation format (such as QPSK, 16QAM, 64QAM, 256QAM and so on). Each symbol is indicated by an I (in-phase) component and a Q (quadrature) component. The amplitude/phase calculator 12b calculates an amplitude and a phase of each symbol based on an I component signal and a Q component signal output from the I/Q mapper 12a. The modulation information generator 11 is implemented by, for example, a processor system that includes a processor element and a memory. Alternatively, the modulation information generator 11 may be implemented by a digital signal processing circuit.

The modulation information generator 11 generates modulation information based on the data signal. The modulation information includes amplitude information and phase information respectively indicating an amplitude and a phase of a transmission symbol. Note that the modulation information generator 11 does not need to include the I/Q mapper 12a. That is, the modulation information generator 11 may generate the amplitude information and the phase information respectively indicating an amplitude and a phase of a transmission symbol based on the input data signal without using an I/Q mapper.

The pulse width modulator 13 generates a pulse width modulated signal (PWM signal) based on the amplitude information and the phase information generated by the modulation information generator 11. A pulse width of the PWM signal depends on the amplitude information. A position of a pulse of the PWM signal in the time domain (that is, timing) depends on the phase information. Here, the pulse width modulator 13 generates the PWM signal according to a channel instruction. The channel instruction indicates a frequency channel used by the transmission device 10 in a communication system in which a plurality of frequency channels of different carrier frequencies are multiplexed. That is, the channel instruction specifies a carrier frequency of a modulated signal transmitted by the transmission device 10. The channel instruction is generated by, for example, a user or a network management system. Then the channel instruction is given to the pulse width modulator 13 and the BPF 15 from a controller (not illustrated in FIG. 3) implemented in the transmission device 10.

The amplifier 14 amplifies the PWM signal generated by the pulse width modulator 13. Here, since the PWM signal is a two-level signal (in monopolar PWM), the amplifier 14 can amplify the PWM signal by switching operation. Thus, the amplifier 14 may be implemented by, for example, an efficient class-D high-power amplifier. The BPF 15 passes a carrier frequency of an output signal of the transmission device 10 (that is, an analog modulated signal transmitted by the transmission device 10) according to the channel instruction. A width of the passband of the BPF 15 may be determined based on a bit rate of the data signal and a modulation format. In addition, the BPF 15 may be implemented by, for example, a frequency tunable bandpass filter. Note that if the transmission device 10 transmits an optical signal to a receiver by RoF or IFoF, an output signal of the BPF 15 is converted into an optical signal by an E/O device 16.

When the transmission device 10 is implemented in the remote radio unit of the distributed antenna system, the output signal of the BPF 15 is transmitted to a mobile station via an antenna. At this point, the output signal of the BPF 15 may be up-converted to a desired frequency band as necessary.

In the transmission device 10, an input signal S(t) of the pulse width modulator 13 may be expressed by formula (1).

S(t)=Aᵢₙ(t)exp{φᵢₙ} (1)

Aᵢₙ indicates the amplitude information. φᵢₙ indicates the phase information.

The PWM signal output from the pulse width modulator 13 is amplified by the amplifier 14 with a gain G. The BPF 15 extracts a frequency component f_{c} specified by the channel instruction from the amplified PWM signal. Note that, as described above, the BPF 15 has a passband of a specified bandwidth. In addition, in the descriptions below, the frequency f_{c} is a fundamental frequency of an oscillation signal used in the pulse width modulator 13. In this case, the output signal Sₒᵤₜ(t) of the BPF 15 may be expressed by formula (2).

Sₒᵤₜ(t)=Aₒᵤₜ(t)exp{ω_{c}t+ωₒᵤₜ}

ω_{c}=2π·f_{c} (2)

The BPF 15 removes high-order frequency components (that is, harmonics) generated in the pulse width modulator 13 and the amplifier 14. Here, it is assumed that the gain G of the amplifier 14 is “1” to simplify the description. By doing this, the amplifier 14 can be omitted in the description of the operations of the transmission device 10.

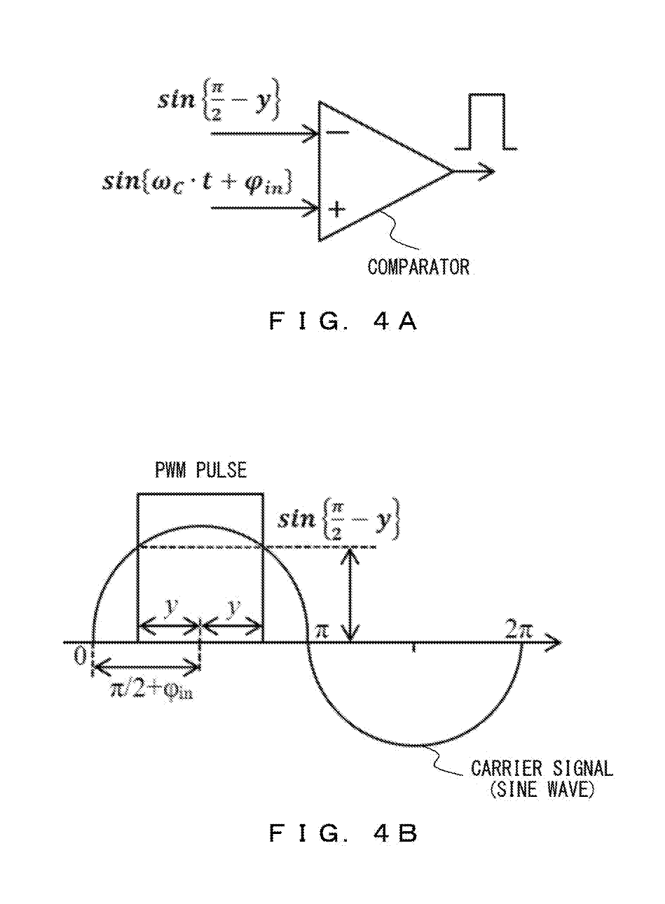

FIGS. 4A and 4B illustrate an outline of an operation of the pulse width modulator 13. The pulse width modulator 13 includes a comparator illustrated in FIG. 4A. A threshold signal is input to a non-inverting input terminal of the comparator, and a carrier signal is input to an inverting input signal. It is assumed that the carrier signal is expressed by a sine wave below.

Carrier signal: sin {ω_{c}+φᵢₙ}

In this case, as illustrated in FIG. 4B, a pulse is generated when the carrier signal is higher than the threshold signal. Note that when the threshold signal is expressed by the formula below, a width of the pulse is indicated by using y, as illustrated in FIG. 4B.

Threshold signal: sin {π/2−y}

In other words, when the threshold signal above is given to the comparator, a PWM signal in which a pulse width depends on y is generated. In addition, a position of the pulse in the time domain is controlled by the phase information φᵢₙ.

y in the threshold signal is generated based on the amplitude information Aᵢₙ as described below. In addition, when an oscillation signal of a frequency f_{c} (ω_{c}=2πf_{c}) is generated in the pulse width modulator 13, a phase of the oscillation signal is controlled by the phase information φᵢₙ. Thus, when the amplitude information Aᵢₙ and the phase information φᵢₙ is given, the pulse width modulator 13 generates a PWM signal including a pulse illustrated in FIG. 4B.

In the embodiment illustrated in FIGS. 4A and 4B, a pulse width of the PWM signal can be calculated according to the threshold signal that is expressed by a sine function. The threshold signal is generated from the amplitude information Aᵢₙ. Thus, the pulse width of the PWM signal is not linear with respect to the amplitude information Aᵢₙ. In this case, an output signal of the pulse width modulator 13 may be distorted with respect to the input signal (Aᵢₙ and φᵢₙ). However, when the BPF 15 extracts a fundamental frequency component (f_{c}) from the PWM signal, the output signal of the BPF 15 is linear with respect to the input signal at the fundamental frequency.

An ideal pulse width modulation does not generate nonlinear distortion in amplitude and phase at the fundamental frequency. That is, formulas (3) and (4) represent a state in which pulse width modulation is linear at the fundamental frequency.

Aₒᵤₜ=k·Aᵢₙ (3)

φₒᵤₜ=φᵢₙ (4)

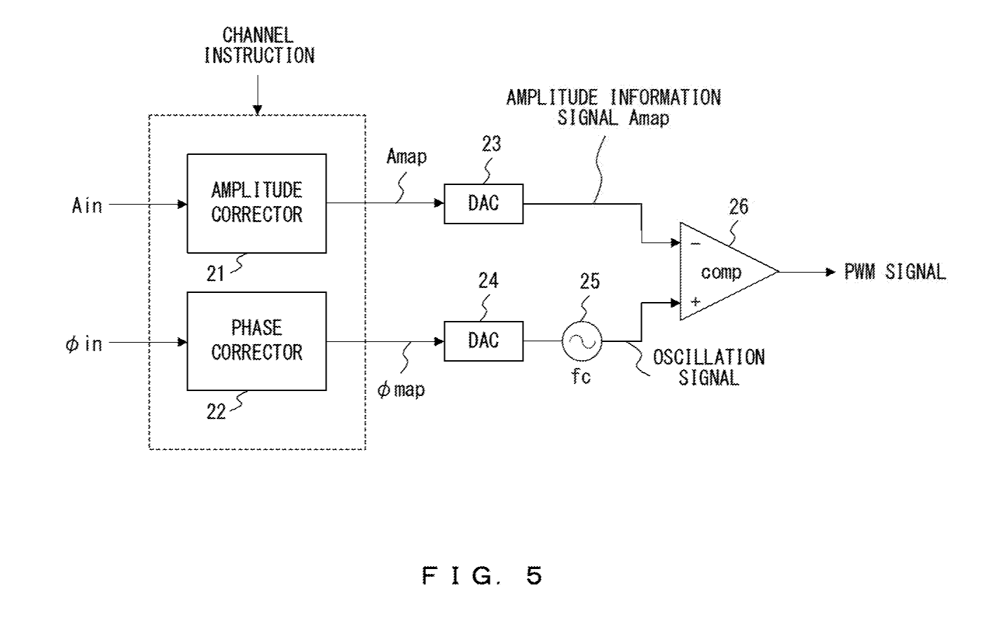

FIG. 5 illustrates an example of the pulse width modulator 13. The pulse width modulator 13 includes an amplitude corrector 21, a phase corrector 22, D/A converters (DAC: Digital-to-Analog converter) 23 and 24, an oscillator 25, and a comparator 26 in this example, as illustrated in FIG. 5.

The amplitude corrector 21 corrects the amplitude information Aᵢₙ according to the channel instruction so as to generate the amplitude information Aₘₐₚ. The phase corrector 22 corrects the phase information φᵢₙ according to the channel instruction so as to generate the phase information φₘₐₚ. The D/A converter 23 converts the amplitude information Aₘₐₚ into an analog signal. In the description below, this analog signal may be referred to as an amplitude information signal. That is, the D/A converter 23 generates the amplitude information signal Aₘₐₚ from the amplitude information Aₘₐₚ by digital-to-analog conversion. The D/A converter 24 converts the phase information φₘₐₚ into an analog signal. In the description below, this analog signal may be referred to as a phase information signal. That is, the D/A converter 24 generates the phase information signal φₘₐₚ from the phase information φₘₐₚ by digital-to-analog conversion.

The oscillator 25 generates an oscillation signal of a specified frequency f_{c}. A waveform of the oscillation signal is, for example, a sine wave. A phase of the oscillation signal is controlled by the phase information signal φₘₐₚ. The frequency f_{c} of the oscillation signal is substantially constant (does not depend on the phase information signal φₘₐₚ). The oscillator 25 may be implemented by, for example, a voltage controlled oscillator (VCO). The comparator 26 generates a PWM signal based on comparison between the amplitude information signal Aₘₐₚ and the oscillation signal. In this example, a pulse is generated when the oscillation signal is higher than the amplitude information signal Aₘₐₚ. Note that the amplitude information signal Aₘₐₚ and the oscillation signal correspond to the threshold signal: sin {π/2−y} and the carrier signal: sin {ω_{c}+φᵢₙ} illustrated in FIG. 4A, respectively.

The amplitude corrector 21 and the phase corrector 22 are implemented by, for example, a processor system that includes a processor element and a memory. In this case, the modulation information generator 11, the amplitude corrector 21 and the phase corrector 22 may be implemented by one processor system or by a plurality of processor systems. Alternatively, the amplitude corrector 21 and the phase corrector 22 may be implemented by a digital signal processor (DSP) or a digital signal processing circuit.

Now it is assumed that the amplitude corrector 21 and the phase corrector 22 do not perform a correcting process (that is, Aᵢₙ=ₘₐₚ, φᵢₙ=φₘₐₚ). In this case, a spectrum of a PWM signal output from the pulse width modulator 13 can be expressed by a Fourier series in formula (5).

$$w ( t , y , ϕ ) = \frac{y}{π} + \frac{2}{π} {\sum }_{m = 1}^{∞} [ \frac{{( - 1 )}^{m}}{2 m} sin \{ 2 my \} cos \{ 2 m ( {ω}_{c} t + ϕ ) \} + \frac{{( - 1 )}^{m + 1}}{2 m - 1} sin \{ ( 2 m - 1 ) y \} sin \{ ( 2 m - 1 ) ( {ω}_{c} t + ϕ ) \} \qquad ( 5 )$$

y indicates a pulse width illustrated in FIG. 4B. ω_{c} indicates an angular frequency of an oscillation signal generated by the oscillator 25. Each coefficient in the Fourier series depends on a phase φ and a pulse width y. The pulse width y depends on an amplitude A. Thus, when the phase φ and/or the amplitude A is a time-varying function, each coefficient in the Fourier series varies with respect to time. Note that document F. H. Raab (Radio Frequency Pulse Width Modulation) describes a Fourier series that indicates a spectrum of a PWM signal.

A fundamental frequency component of the PWM signal is obtained by giving m=1 to the formula (5). That is, the fundamental frequency component S(1) can be expressed by formula (6).

$$S ( 1 ) = \frac{2}{π} sin \{ y \} sin \{ {ω}_{c} t + ϕ \} = {A}_{out} \cdot sin \{ {ω}_{c} t + ϕ \} \\ {A}_{out} = \frac{2}{π} sin \{ y \} \qquad ( 6 )$$

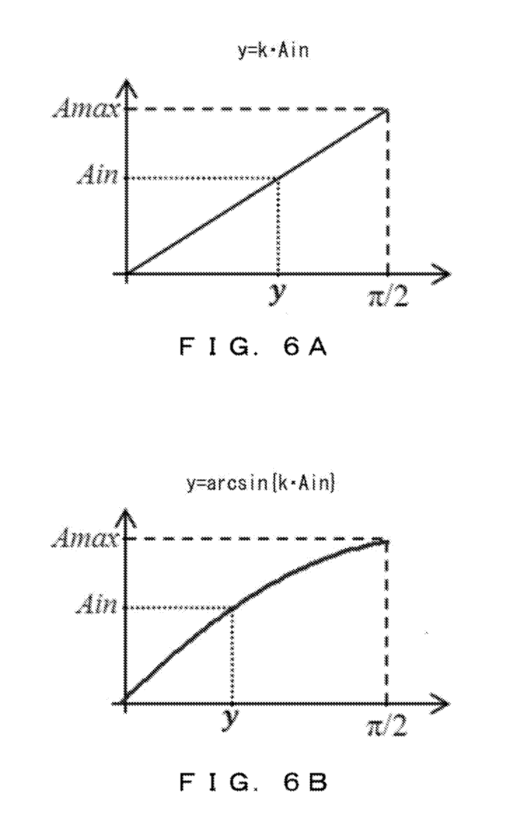

The formula (6) indicates that the amplitude Aₒᵤₜ of the fundamental frequency component is related to the pulse width y by a nonlinear function (that is, a sine function). Here, it is assumed that the pulse width y is linear with respect to the amplitude Aᵢₙ, as illustrated in FIG. 6A. That is, there is a relationship between the pulse width y and the amplitude Aᵢₙ, as expressed by formula (7). Note that Aₘₐₓ is a maximum value of Aᵢₙ.

$$y = {k}_{1} \cdot {A}_{in} \\ {k}_{1} = \frac{π}{2} \cdot \frac{1}{{A}_{max}} \qquad ( 7 )$$

In this case, when the amplitude Aᵢₙ of the input signal varies within a range from zero to Aₘₐₓ, the pulse width y varies from zero to π/2, as illustrated in FIG. 6A. Thus, a transfer function of the pulse width modulator 13 with respect to the amplitude information A can be expressed by formula (8).

Aₒᵤₜ=sin {y}=sin {k₁·Aᵢₙ} (8)

As described, the amplitude Aₒᵤₜ of the output signal is obtained from the amplitude Aᵢₙ of the input signal by using a sine function. That is, the amplitude Aₒᵤₜ is nonlinear with respect to the amplitude Aᵢₙ. In this case, an output signal of the transmission device 10 is distorted and thus communication quality may deteriorate.

This problem may be solved by correcting the amplitude Aᵢₙ such that the amplitude Aₒᵤₜ is linear with respect to the amplitude Aᵢₙ, for example. That is, pre-distortion is performed on the amplitude Aᵢₙ such that the amplitude Aₒᵤₜ is linear with respect to the amplitude Aᵢₙ. As an example, the amplitude Aᵢₙ is corrected (or pre-distorted) by using an inverse sine function (that is, an arcsine) as illustrated in FIG. 6B. By doing this, formula (9) is obtained.

y=arcsin {k₁·Aᵢₙ} (9)

In addition, when formula (9) is given to formula (8), formula (10) is obtained.

Aₒᵤₜ=sin {y}=sin [arcsin {k₁·Aᵢₙ}]=k₁·Aᵢₙ (10)

The correction described above is performed by the amplitude corrector 21 in the pulse width modulator 13 illustrated in FIG. 5. That is, the amplitude corrector 21 corrects the amplitude information Aᵢₙ by using formula (11) so as to generate the amplitude information Aₘₐₚ. Note that in the description below, the correction performed by the amplitude corrector 21 may be referred to as “mapping”.

$${A}_{map} = sin [ \frac{π}{2} - arcsin \{ {A}_{in} \} ] \qquad ( 11 )$$

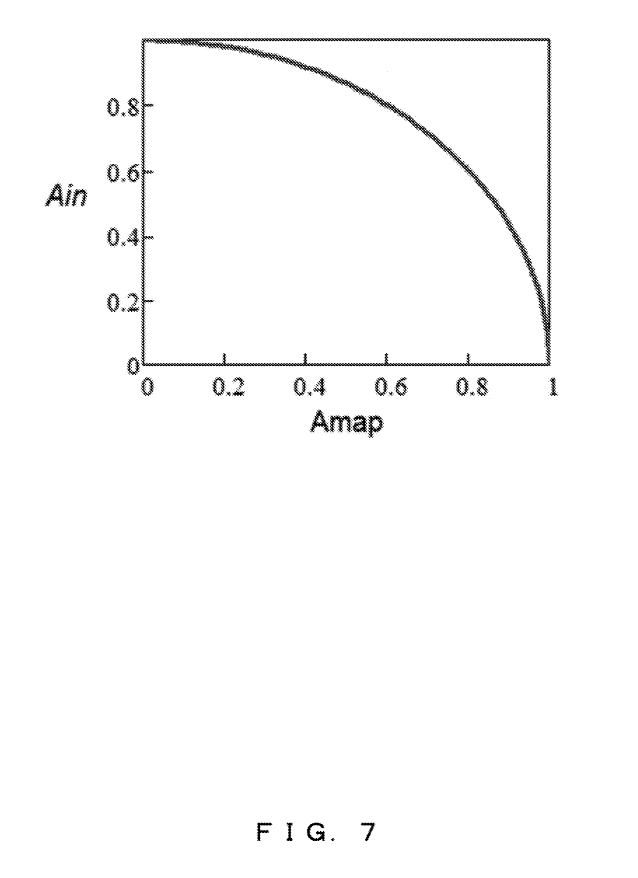

FIG. 7 illustrates an example of a mapping by the amplitude corrector 21. In FIG. 7, the amplitude information Aᵢₙ input to the pulse width modulator 13 and the amplitude information Aₘₐₚ corrected by the pulse width modulator 13 are normalized. According to the mapping illustrated in FIG. 7, for example, Aₘₐₚ=0.6 is obtained for Aᵢₙ=0.8, and Aₘₐₚ=0.8 is obtained for Aᵢₙ=0.6.

As described, the amplitude corrector 21 performs pre-distortion on the amplitude information Aᵢₙ by using an inverse sine function. As a result, the amplitude information Aₒᵤₜ is linear with respect to the amplitude information Aᵢₙ. That is, the transmission device 10 can transmit anon-distorted signal.

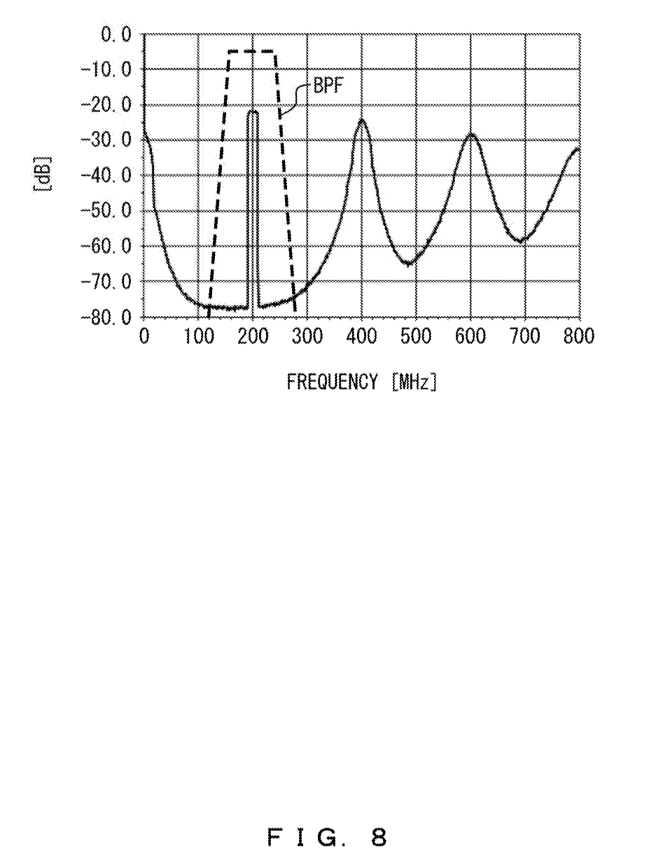

FIG. 8 illustrates an example of a spectrum of an output signal from the pulse width modulator 13. Specifically, FIG. 8 illustrates an example of a spectrum (PSD: power spectrum density) of the PWM signal output from the comparator 26 illustrated in FIG. 5. In this example, the amplitude information Aᵢₙ and the phase information φᵢₙ that indicate an OFDM signal of 20 MHz are input to the pulse width modulator 13. The amplitude corrector 21 corrects the amplitude information Aᵢₙ according to formula (11) so as to generate amplitude information Aₘₐₚ. The phase corrector 22 does not perform a correction process. That is, φᵢₙ=φₘₐₚ. The frequency f_{c} of the oscillation signal generated by the oscillator 25 is 200 MHz.

In this case, the output signal (Aₘₐₚ, φₘₐₚ) of the pulse width modulator 13 is linear with respect to the input signal (Aᵢₙ, φᵢₙ) at the fundamental frequency (that is, f_{c}). Accordingly, a non-distorted modulated signal is generated at the frequency f_{c}.

A center frequency of a passband of the BPF 15 is controlled to be the frequency f_{c}, as illustrated in FIG. 8. By doing this, harmonics on the PWM signal are removed by the BPF 15. That is, the second order harmonic, third order harmonic, . . . (400 MHz, 600 MHz, . . . ) are removed. Therefore, the transmission device 10 can transmit data in a non-distorted modulated signal.

Channel Selection

The transmission device 10 can transmit data by using a desired frequency channel. That is, the transmission device 10 can transmit data at a carrier frequency specified by the channel instruction.

When the transmission device 10 transmits data at a carrier frequency that is higher than the fundamental frequency, the transmission device 10 uses harmonics. For example, it is assumed that the frequency f_{c} of the oscillator 25 is 200 MHz. In this case, when a frequency channel of 400 MHz is specified, the transmission device 10 transmits data by using the second harmonic. When a frequency channel of 600 MHz is specified, the transmission device 10 transmits data by using the third harmonic.

The spectrum of the PWM signal output from the pulse width modulator 13 can be expressed by the Fourier series in formula (5). Here, an amplitude component A2ₒᵤₜ of the second harmonic is obtained by giving m=1 to formula (5), and is expressed by formula (12).

$$\begin{matrix}A {2}_{out} = ( \frac{- {1}^{m}}{2 m} ) sin \{ 2 my \} cos \{ 2 m ( {ω}_{c} t + ϕ ) \} \\ = \frac{1}{2} sin \{ 2 y \} cos \{ 2 {ω}_{c} t + 2 ϕ \} \\ = {A}_{out 2} \cdot cos \{ 2 {ω}_{c} t + 2 ϕ \}\end{matrix} \\ {A}_{out 2} = \frac{1}{2} sin \{ 2 y \} \qquad ( 12 )$$

Considering formulas (9) and (10), formulas (13) and (14) are obtained based on formula (12).

$$\begin{matrix}y = \frac{1}{2} arcsin \{ {A}_{in} \} & ( 13 ) \\ A {2}_{out} = \frac{1}{2} sin \{ 2 y \} = \frac{1}{2} sin [ arcsin \{ {A}_{in} \} ] = \frac{1}{2} {A}_{in} & ( 14 )\end{matrix}$$

As described, when the pulse width y is calculated from the input amplitude Aᵢₙ according to formula (13), the amplitude component A2ₒᵤₜ of the second harmonic is linear with respect to the input amplitude Aᵢₙ as expressed by formula (14). Thus, when the transmission device 10 transmits data by using the second harmonic, the amplitude corrector 21 corrects the amplitude information Aᵢₙ according to formula (15) so as to generate amplitude information Aₘₐₚ.

$${A}_{map} = sin \{ \frac{π}{2} - \frac{1}{2} arcsin ( {A}_{in} ) \} \qquad ( 15 )$$

Phase information φ controls a phase of the oscillation signal generated by the oscillator 25, as described above. A position of a pulse of the PWM signal generated by the pulse width modulator 13 is determined in accordance with a phase of the oscillation signal. Thus, the position of a pulse of the PWM signal is controlled according to the phase information φ. In addition, a phase of an output signal obtained by filtering the PWM signal by the BPF 15 depends on the position of a pulse. Therefore, the phase of the output signal of the BPF 15 is controlled by the phase information φ.

Here, it is assumed that when the input phase is φᵢₙ, a position of a pulse of the PWM signal generated by the pulse width modulator 13 is shifted by Δp with respect to a reference point. In addition, a phase of each of the frequency components (the fundamental frequency and the harmonics) is shifted according to Δp in the output signal of the BPF 15. Thus, in the output signal of the BPF 15, when a phase of the fundamental frequency f_{c} is shifted by φᵢₙ, a phase of the second harmonic (2f_{c}) is shifted by 2φᵢₙ, and a phase of the third harmonic (3f_{c}) is shifted by 3φᵢₙ.

However, when a phase of a transmitting symbol generated from the input data is φᵢₙ, the transmission device 10 is requested to transmit a signal in phase φᵢₙ for any frequency channel. Thus, the transmission device 10 corrects the phase information according to a specified frequency channel by using the phase corrector 22. For example, when data is transmitted using a frequency of twice the fundamental frequency (that is, the second harmonic), the phase corrector 22 divides a value of the phase information by two. That is, the phase information φᵢₙ is corrected by formula (16).

$${ϕ}_{map} = \frac{1}{2} {ϕ}_{in} \qquad ( 16 )$$

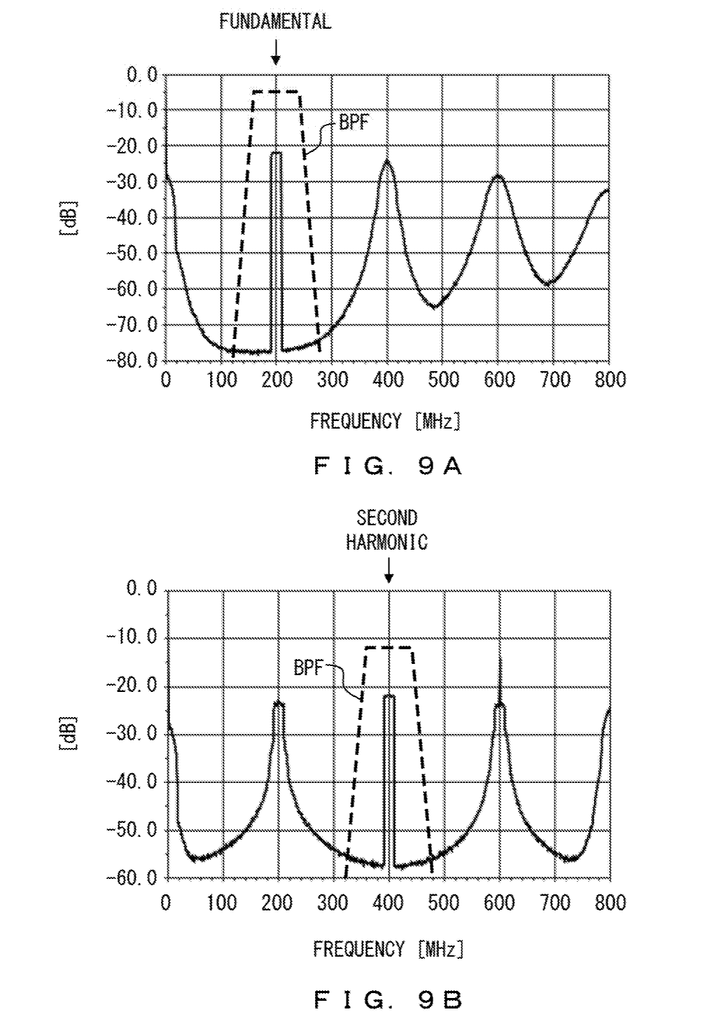

FIGS. 9A and 9B illustrate examples of frequency channel selection. Similar to the example illustrated in FIG. 8, the amplitude information Aᵢₙ and the phase information φᵢₙ that indicate an OFDM signal of 20 MHz are input to the pulse width modulator 13. The frequency of the oscillation signal generated by the oscillator 25 (that is, the fundamental frequency f_{c}) is 200 MHz.

When the transmission device 10 transmits a data signal using the fundamental frequency, the amplitude corrector 21 generates the amplitude information Aₘₐₚ from the amplitude information Aᵢₙ according to formula (11). At this point, the phase corrector 22 does not correct the phase information φᵢₙ. That is, φₘₐₚ=φᵢₙ. In this case, the output signal of the pulse width modulator 13 is linear with respect to its input signal at the fundamental frequency f_{c}. The oscillator 25 generates an oscillation signal that has a phase corresponding to the phase information φₘₐₚ. The comparator 26 generates the PWM signal based on the comparison between the amplitude information signal Aₘₐₚ and the oscillation signal. Here, the transmission device 10 configures a center frequency of a passband of the BPF 15 at f_{c}, as illustrated in FIG. 9A. As a result, the fundamental frequency component is extracted from the PWM signal. Accordingly, the transmission device 10 can transmit a non-distorted modulated signal via a frequency channel of the carrier frequency f_{c}.

When the transmission device 10 transmits a data signal using a second harmonic, the amplitude corrector 21 generates the amplitude information Aₘₐₚ from the amplitude information Aᵢₙ according to formula (15). The phase corrector generates the phase information φₘₐₚ from the phase information φᵢₙ according to formula (16). In this case, the output signal of the pulse width modulator 13 is linear with respect to its input signal at the frequency of the second harmonic (2f_{c}). The oscillator 25 generates an oscillation signal that has a phase corresponding to the phase information φₘₐₚ The comparator 26 generates the PWM signal based on the comparison between the amplitude information signal Aₘₐₚ and the oscillation signal. Here, the transmission device 10 configures a center frequency of a passband of the BPF 15 at 2f_{c}, as illustrated in FIG. 9B. As a result, the frequency component of the second harmonic is extracted from the PWM signal. Accordingly, the transmission device 10 can transmit a non-distorted modulated signal via a frequency channel of the carrier frequency 2f_{c}.

When compared with a case in which the fundamental frequency is used, the carrier frequency of the modulated signal transmitted by the transmission device 10 is double in a case in which the second harmonic is used. However, the phase information is divided by 2 in the phase corrector 22. Thus, phases of the modulated signals are substantially the same as each other between the case in which the fundamental frequency is used and the case in which the second harmonic is used.

In the embodiment described above, the carrier frequency is the fundamental frequency or the second harmonic frequency; however, the invention is not limited to this configuration. That is, the transmission device 10 can transmit data by using third or higher order harmonics.

When the transmission device 10 transmits data at a desired carrier frequency (fundamental frequency or its harmonics), the amplitude corrector 21 corrects the amplitude information A according to formula (17)

$${A}_{map} = sin \{ \frac{π}{2} - \frac{1}{N} arcsin ( {A}_{in} ) \} \qquad ( 17 )$$

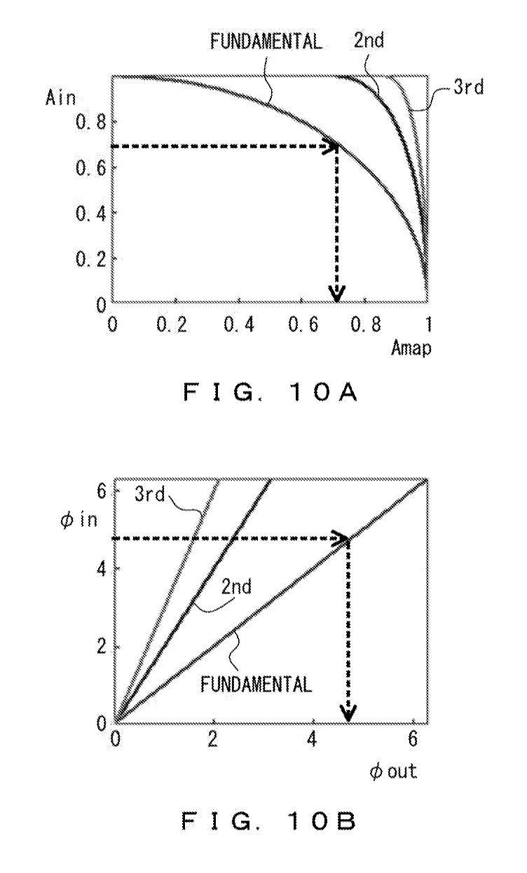

N is a natural number and indicates an order of harmonics. Note that N=1 indicates the fundamental frequency. FIG. 10A illustrates mapping functions (N=1, 2, 3) used by the amplitude corrector 21.

The phase corrector 22 corrects the phase information φ according to formula (18).

$${ϕ}_{map} = \frac{1}{N} {ϕ}_{in} \qquad ( 18 )$$

N is a natural number and indicates an order of harmonics. Note that N=1 indicates the fundamental frequency. FIG. 10B illustrates mapping functions (N=1, 2, 3) used by the phase corrector 22.

As described, the transmission device 10 corrects the amplitude information using the amplitude corrector 21 and corrects the phase information using the phase corrector 22 in accordance with a specified frequency channel (that is, a specified carrier frequency) for transmitting data. In addition, the transmission device 10 controls a center frequency of a passband of the BPF 15 in accordance with the specified frequency channel for transmitting data. By doing these operations, the transmission device 10 can transmit a non-distorted modulated signal using a desired frequency channel.

The frequency of the oscillator 25 used in the pulse width modulator 13 is constant. That is, when the frequency of the oscillator 25 is the fundamental frequency, the transmission device 10 can transmit data at a desired carrier frequency by using harmonics. Thus, according to the embodiment, the transmission device 10 can transmit data at a high carrier frequency without increasing an operation frequency of a circuit in the pulse width modulator 13. In other words, according to the embodiment, the power consumption of the pulse width modulator 13 is reduced. Note that since it is not necessary to increase an operation frequency of the comparator, the power consumption is reduced and a transmission device may be implemented without using expensive components (for example, a high-speed comparator).

The amplitude corrector 21 generates the amplitude information Aₘₐₚ from the amplitude information Aᵢₙ as described above. At this point, the amplitude corrector 21 may calculate the amplitude information Aₘₐₚ from the amplitude information Aᵢₙ by giving a variable N that identifies a frequency channel to be used to formula (17). Alternatively, the amplitude corrector 21 may obtain the amplitude information Aₘₐₚ from the amplitude information Aᵢₙ by using a lookup table that stores mapping data illustrated in FIG. 10A. In this case, the amplitude corrector 21 accesses the lookup table with the amplitude information Aᵢₙ and the variable N that identifies the frequency channel to be used.

The phase corrector 22 generates the phase information φₘₐₚ from the phase information φᵢₙ as described above. At this point, the phase corrector 22 may calculate the phase information φₘₐₚ from the phase information φᵢₙ by giving a variable N that identifies a frequency channel to be used to formula (18). Alternatively, the phase corrector 22 may obtain the phase information φₘₐₚ from the phase information φᵢₙ by using a lookup table that stores mapping data illustrated in FIG. 10B. In this case, the phase corrector 22 accesses the lookup table with the phase information φᵢₙ and the variable N that identifies the frequency channel to be used.

In the example illustrated in FIG. 5, the phase information φₘₐₚ output from the phase corrector 22 is converted into an analog signal by the D/A converter 24 and fed to the oscillator 25. Then the oscillator 25 generates an oscillation signal that has a phase corresponding to the phase information φₘₐₚ. Note that the invention is not limited to this configuration. For example, the transmission device 10 may be configured to include a high-speed D/A converter that has a function equivalent to a combination of the D/A converter 24 and the oscillator 25 in place of the D/A converter 24 and the oscillator 25. In this case, the high-speed D/A converter generates an oscillation signal that has a phase corresponding to the phase information φₘₐₚ. The high-speed D/A converter may be implemented by, for example, an RF-D/A converter.

In the examples described above, the transmission device 10 is implemented in the digital processing unit or the remote radio unit of the distributed antenna system; however, the invention is not limited to the configuration. For example, the pulse width modulator 13 may be implemented in the digital processing unit, while the amplifier 14 and the BPF 15 may be implemented in the remote radio unit. In this case, the PWM signal generated by the pulse width modulator 13 may be transmitted to the remote radio unit via a communication cable.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A transmission device that outputs a modulated signal based on amplitude information and phase information respectively indicating an amplitude and a phase of a transmission symbol, the transmission device comprising:
an amplitude corrector configured to correct the amplitude information based on a specified carrier frequency;
a phase corrector configured to correct the phase information based on the carrier frequency;
a D/A (digital-to-analog) converter configured to convert the amplitude information corrected by the amplitude corrector into an analog signal so as to generate an amplitude information signal;
an oscillation signal generation circuit configured to generate an oscillation signal that has a phase corresponding to the phase information corrected by the phase corrector;
a comparator configured to generate a pulse width modulated signal based on a comparison between the amplitude information signal and the oscillation signal; and
a bandpass filter configured to filter the pulse width modulated signal so as to output the modulated signal.

2. The transmission device according to claim 1, further comprising
an amplifier that is implemented between the comparator and the bandpass filter, and is configured to amplify the pulse width modulated signal.

3. The transmission device according to claim 1, wherein
a center frequency of a passband of the bandpass filter is controlled to be substantially the same as the carrier frequency.

4. The transmission device according to claim 1, wherein
when a waveform of the oscillation signal is a sine wave, Aᵢₙ indicates the amplitude information input to the amplitude corrector, Aₘₐₚ indicates the corrected amplitude information output from the amplitude corrector, and the carrier frequency is N times the frequency of the oscillation signal, the amplitude corrector corrects the amplitude information by Aₘₐₚ=sin [π/2−arcsin {Aᵢₙ}/N].

5. The transmission device according to claim 4, wherein
when φᵢₙ indicates the phase information input to the phase corrector and φₘₐₚ indicates the corrected phase information output from the phase corrector, the phase corrector corrects the phase information by φₘₐₚ=φᵢₙ/N.

6. A pulse width modulator that generates a pulse width modulated signal based on amplitude information and phase information respectively indicate an amplitude and a phase of a transmission symbol, the pulse width modulator comprising:
an amplitude corrector configured to correct the amplitude information based on a specified carrier frequency;
a phase corrector configured to correct the phase information based on the carrier frequency;
a D/A (digital-to-analog) converter configured to convert the amplitude information corrected by the amplitude corrector into an analog signal so as to generate an amplitude information signal;
an oscillation signal generation circuit configured to generate an oscillation signal that has a phase corresponding to the phase information corrected by the phase corrector; and
a comparator configured to generate a pulse width modulated signal based on a comparison between the amplitude information signal and the oscillation signal.

7. A transmission method that outputs a modulated signal based on amplitude information and phase information respectively indicate an amplitude and a phase of a transmission symbol, the transmission method comprising:
correcting the amplitude information based on a specified carrier frequency;
correcting the phase information based on the carrier frequency;
converting the corrected amplitude information into an analog signal so as to generate an amplitude information signal;
generating an oscillation signal that has a phase corresponding to the corrected phase information;
generating a pulse width modulated signal based on a comparison between the amplitude information signal and the oscillation signal by using a comparator; and
filtering the pulse width modulated signal by using a bandpass filter so as to output the modulated signal.
